(19) United States
(12) Patent Application Publication
(10) Pub. No.: US 2011/0113131 A1
(43) Pub. Date: May 12, 2011

(54) Method of Load Balance Based on BS Architecture

(75) Inventors: YIJING DUANMU, Nanjing (CN); GANG LI, Nanjing (CN); GUOXIANG LIU, Nanjing (CN); YOUGENG ZHANG, Nanjing (CN); BIN LIANG, Nanjing (CN); HUA LI, Nanjing (CN)

(73) Assignee: LINKAGE TECHNOLOGY GROUP CO., LTD., Nanjing (CN)

(21) Appl. No.: 12/942,994

(22) Filed: Nov. 9, 2010

(30) Foreign Application Priority Data
Nov. 10, 2009 (CN) 200910212674.7

(51) Int. Cl. G06F 15/173

(52) U.S. Cl. 709/223

(57) ABSTRACT

The invention provides a method of loading balance that is based on BS structure, it includes the following steps: using a 4-layers switch to distribute the application request for the proxy server; using the so-called proxy server to distribute application request for application server; and establishing the corresponding WEBLOGIC clusters in accordance with each application request. This invention provides method of loading balance that is based on BS structure that is rationally configure the connection between 4-layers switch and the proxy layer of proxy server; at the same time, maintains the loading balance of the application server and eliminates the single-spot fault by utilizing the advantages of the WEBLOGIC clusters server communication and the back-up synchronization of the users' calling back.

### CROSS REFERENCE TO RELATED PATENT APPLICATION

The present application claims the priority of Chinese patent application No. 200910212674.7 filed on Nov. 10, 2009, which application is incorporated herein by reference.

### FIELD OF THE INVENTION

This invention is related to the technology field of the computer cluster, in particular with a method of loading balance that is based on BS architecture.

### BACKGROUND OF THE INVENTION

As telecom carriers' BSS/OSS system has gradually evolved from the traditional CS structure to BS structure, and products and services they provided tends to be more diversified, one must focus on the improvement of the simplification and efficiency of the system, both of which are the critical indicator of the system, in order to support the number of telecom users' BS structural system. At the same time, it can take advantage of the BS structure itself, such as unified management, rapid response for development requirements, and easy to upgrade the system and etc to raise customer perception.

As we know, the thread capacity of a WEBLOGIC is 400, but the number of accesses to the telecom operation within a province is much greater than that, and it could result in loading balance issue when the front server experiences excessive accesses. If using multiple WEBLOGIC servers, then it will require a unified dispatch server to allocate these connection requests, such as using back-up TUXEDO failover to conduct the unified management.

### SUMMARY OF THE INVENTION

Therefore, this invention provides a method of loading balance that is based on BS structure, and this method realizes the smooth upgrade for the application after loading balance and the expansion of the host device.

The invention provides a method of loading balance that is based on BS structure, it includes the following steps: using a 4-layers switch to distribute the application request for the proxy server; using the so-called proxy server to distribute application request for application server; and establishing the corresponding WEBLOGIC clusters in accordance with each application request.

One steps forward, establishing the corresponding WEBLOGIC clusters includes following steps: Establishing corresponding WEBLOGIC server in accordance with each physical host; and defining multiple mentioned WEBLOGIC servers and adding into WEBLOGIC clusters.

Further, if the mentioned application server needs to be connected by background WTC, it needs to define remote access point and FAILOVER point.

Further, the mentioned WEBLOGIC clusters use SESSION for internal replication.

Further, the mentioned server would filter and compress all the data that has been transferred through the proxy server.

The benefits of the invention: This invention adopts method of loading balance that is based on BS Structure, equalizes the load of all of the WEB server's Java process, which realizes the loading balance purpose. If client needs to add a physical server, then it only needs to define a corresponding node in the management server and increase the relevant number of WEBLOGIC servers and add into WEBLOGIC clusters directly. After startup, it can share the burden of the server instantly which upgrades the system smoothly.

### BRIEF DESCRIPTION OF THE FIGURES

FIG. 1 is the flow chart of the invention—“method of loading balance that is based on BS structure”.

FIG. 2 is a detailed illustration of the graph in FIG. 1.

### DETAIL DESCRIPTION OF THE INVENTION

In order to make the invention's mentioned and other purposes, features and advantages to be better understood the following paragraphs will use examples and figures to make a further illustration.

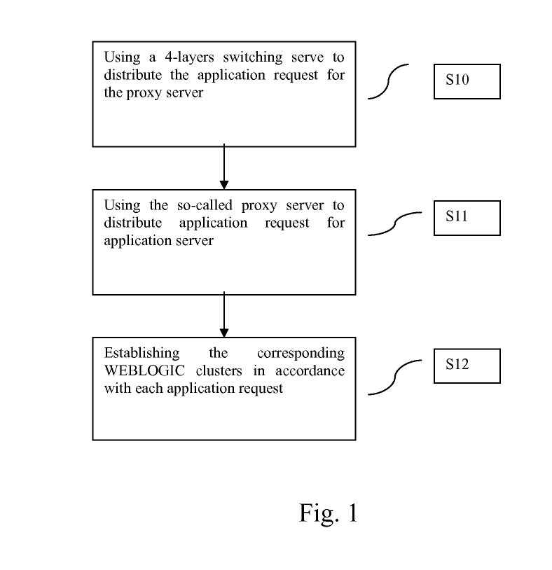

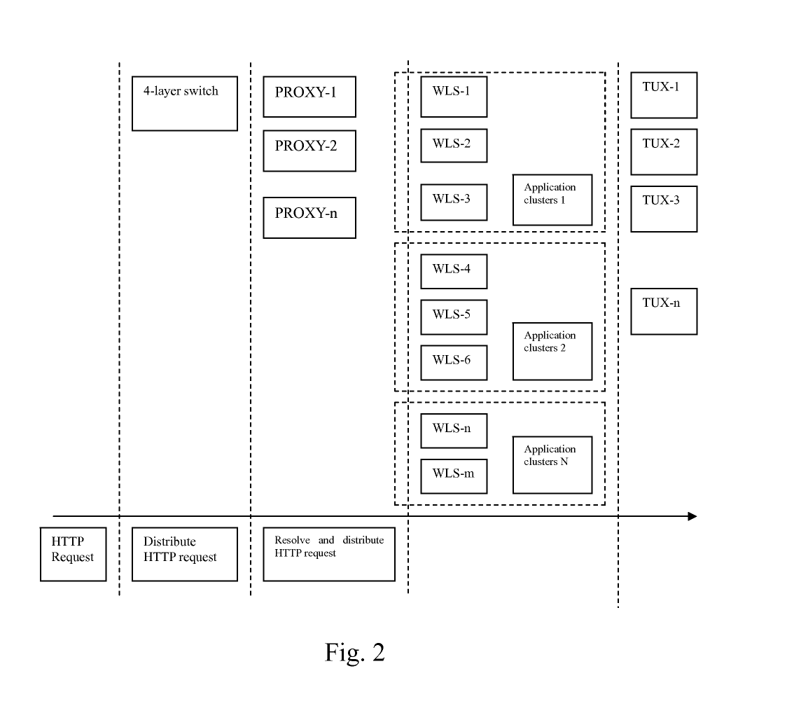

FIG. 1 is the flow chart of the invention—“method of loading balance that is based on BS structure”; FIG. 2 is a detailed illustration of the graph in FIG. 1. Please refer to the FIG. 1 and FIG. 2 simultaneously.

As the figure shows, this invention provides the method of loading balance that is based on the BS structure:

Step S10, using a 4-layers switch to distribute the application request for the proxy server, this application request is the HTTP request. In this practical example, proxy server could be either WEBLOGIC server or the APACHE server.

Step S11, it uses proxy server to allocate application requests for application server. In the detail, proxy server can determine the distribution direction of application request through URL pattern that is used for the resolution purpose. Further, it can use the following calculation method: 1) Rotational distribution; 2) Load calculation; 3) Instant Distribution.

In the example, the proxy server can implements the transmission filter compression for all the HTTP data, and the compression calculation method is gzip, which is benefit for the narrow traffic termination access.

Step S12, according to each application request, it will establish corresponding WEBLOGIC cluster. The details include following steps: establishing corresponding WEBLOGIC server in accordance with each physical host; defining multiple mentioned WEBLOGIC servers and adding into WEBLOGIC clusters.

The definition of physical host is the following:

There is machines definition interface inside of Weblogic Console, and the details are as follow:

1. Initiate the NodeManager in every physical host. AdminServer needs to go through each host's Nodemanger in order to control the physical server's weblogic process in real time.

2. Define physical server's nodemanager address inside of the machine.

The following is the definition of weblogic cluster:

Weblogic clusters can provide good strategy for loading balance of the system and it increases the stability of application dramatically, hereby we use Round-Robin strategy. Also, each application will be deployed in a single cluster. Detail is as the following:

1. Define a weblogic cluster, and the name is A_CLUSTER

2. Deploy A application, and target it into A_CLUSTER

3. Add the defined weblogic server into cluster.

In the example, WEBLOGIC will use HTTP SESSION for internal replication so that the reply message of the user is valid within any WEBLOGIC server of the internal cluster.

HTTP Session replication configuration is as follows:

1. Add PesistentStoreType into application's Web.xml, and the value is “replicated”

2. Make sure each of cluster's Muliticast address and port are different, and the address can be 224.0.0.1-239.255.255.254

Further, if WEBLOGIC server needs to be connected by using the background WTC, then defining the REMOTE ACCESS POINT and FAILOVER POINT.

The configuration of WTC failover node is as follows:

1. Define TUX1, and TUX2, both of which are two different Remote Access Points directing to TUXDO host

2. Use TUX1, TUX2 or TUX2, TUX1 in each of Imported Server, the former is remote access point and the latter is failover point.

FIG. 2 shows that the use of the method of loading balance that is based on BS structure can realize the unified access. For example, the address of 4-layer switch that is released to the public is: 192.168.0.1, the port of 4 layer switch that is released to the public is: 80. The system's unified access is: http://192.168.0.1. For A application's call, it can be http://192.168.0.1/a?service=aaa& . . . URL-Pattern=/a; For B application's call, it can be http://192.168.0.1/b?service=bbb& . . . URL-Pattern=/b. A application is deployed in application clusters 1; B application is deployed in application clusters 2.

Based on FIGS. 1 and 2, the detail of the method of loading balance based on BS structure is as follow:

The address of 4-layer switch that is released to the public: AAA.BBB.CCC.DDD:80, the network address is:

192.168.0.1/255.255.255.0. There are 4 PROXY servers, and the following is the address that is published:

192.168.0.2/255.255.255.0 port: 8080

192.168.0.2/255.255.255.0 port: 8081

192.168.0.3/255.255.255.0 port: 8080

192.168.0.3/255.255.255.0 port: 8081

To configure the 4-layer switch, and using any of the following calculation method to allocate the 80 port's HTTP request into the address of 4 layer switch: 1) Terminate the connection between IP and PROXY IP: PORT, if not, change to another one; 2) Polling the IP of PROXY: PORT, if not, change to another one; 3) Random forwarding, if not, change to another one.

The directory structure that is used by PROXY server is the standard J2EE WEB-application directory structure:

```
proxy/
    WEB-INF/
          web.xml
          weblogic.xml
          lib/
          classes/
```

The following is the example of web.xml:

```
    <!DOCTYPE web-app PUBLIC “-//Sun Microsystems, Inc.//DTD
Web Application 2.3//EN” “http://java.sun.com/dtd/web-app_2_3.dtd”>
    <web-app>
      <servlet>
          <servlet-name>A</servlet-name>
          <servlet-class>
          .servlet.proxy.HttpClusterServlet
          </servlet-class>
          <init-param>
            <param-name>WebLogicCluster</param-name>
            <param-value>
              192.168.0.2:8001|192.168.0.3:8001
            </param-value>
          </init-param>
          <init-param>
            <param-name>CookieName</param-name>
            <param-value>BSS_A_JSESSIONID</param-value>
      </init-param>
      </servlet>
      <servlet>
          <servlet-name>B</servlet-name>
          <servlet-class>
          .servlet.proxy.HttpClusterServlet
          </servlet-class>
          <init-param>
            <param-name>WebLogicCluster</param-name>
            <param-value>
                .168.0.2:8002|192.168.0.2:8002
            </param-value>
          </init-param>
          <init-param>
            <param-name>CookieName</param-name>
            <param-value>BSS_B_JSESSIONID</param-value>
          </init-param>
      </servlet>
      <servlet-mapping>
          <servlet-name>A</servlet-name>
          <url-pattern>/a</url-pattern>
      </servlet-mapping>
      <servlet-mapping>
          <servlet-name>B</servlet-name>
          <url-pattern>/b</url-pattern>
      </servlet-mapping>
      <servlet-mapping>
          <servlet-name>A</servlet-name>
          <url-pattern>/</url-pattern>
      </servlet-mapping>
      <servlet-mapping>
            <servlet-name>A</servlet-name>
          <url-pattern>*.html</url-pattern>
      </servlet-mapping>
      <servlet-mapping>
          <servlet-name>A</servlet-name>
          <url-pattern>*.gif</url-pattern>
      </servlet-mapping>
    </web-app>
```

Just deploy the WEB-application directory into the 4 PROXY servers.

Application server deployed the application requirement of WEBLOGIC server at enterprise-level.

The following is an example for the further illustration: Enterprise applications are divided into two types of application that is A application and B application, both of which visit access through HTTP protocol.

Implementation Steps:

Define server clusters that are used by A application and B application, CLUSTER_A and CLUSTER_B.

Deploy A application in the CLUSTER_A which is located on two WEBLOGIC servers of 8001 port in 192.168.0.2 and 8001 port in 192.168.0.3:8001.

Deploy B application in the CLUSTER_B which is located on two WEBLOGIC servers of 8021 port in 192.168.0.2 and 8002 port in 192.168.0.3:8002.

A is using the standard J2EE WEB-application directory structure:

```
  A/
WEB-INF/
  classes/
  lib/
  web.xml
  weblogic.xml
app/
```

In the weblogic.xml, it needs to define PersistentStoreType=replicated to show users'reply data that is used for cluster synchronization by the memory replication.

Define the connection of the WTC TUXEDO configuration and deploy it to application server.

Define the other resources that are needed by application server, for example: JDBC, JMS and so on.

The case that is mentioned is just used as a practical example, and it's not intended to limit the scope of the invention. Any changes and modifications of the contents within patent application part of the invention should belong to the technical scope of the invention.

What is claimed is:

1. A method of loading balance based on BS architecture including following steps:
using a 4-layers switch to distribute application requests for a plurality of proxy servers;
using the plurality of proxy servers to distribute the application requests for a plurality of application servers; and
establishing corresponding plurality of WEBLOGIC clusters in accordance with the application request;
wherein the establishing corresponding plurality of WEBLOGIC clusters includes following steps:
establishing corresponding plurality of WEBLOGIC servers in accordance with a plurality of physical hosts;
defining each one of plurality of WEBLOGIC servers and adding the defined WEBLOGIC servers into the WEBLOGIC clusters respectively.

2. The method of loading balance based on BS architecture of claim 1, wherein if one of the plurality of application servers needs to be connected by using background WTC, then a Remote Access Point and a FAILOVER Point shall be defined.

3. The method of loading balance based on BS architecture of claim 1, wherein the plurality of WEBLOGIC clusters use SESSION for internal replication.

4. The method of loading balance based on BS architecture of claim 1, wherein the plurality of proxy servers shall filter and compress all data passing through thereof.
